(19) United States
(12) Patent Application Publication
(10) Pub. No.: US 2026/0270913 A1
(43) Pub. Date: Sep. 10, 2026

(54) SYSTEMS AND METHODS FOR REGULATING UPLINK TRANSMISSION TIMING DIFFERENCES AT A USER EQUIPMENT

(71) Applicant: APPLE INC., Cupertino, CA (US)

(72) Inventors: Qiming Li, Beijing (CN); Jie Cui, San Jose, CA (US); Xiang Chen, Campbell, CA (US); Fangli Xu, Beijing (CN); Dawei Zhang, Saratoga, CA (US); Yang Tang, San Jose, CA (US)

(21) Appl. No.: 19/167,249

(22) PCT Filed: May 5, 2023
(86) PCT No.: PCT/CN2023/092293

§ 371 Date: Sep. 19, 2025

(51) Int. Cl. H04W 56/00; H04W 24/10; H04W 28/06; H04W 72/1268; H04W 76/38

(52) U.S. Cl. CPC H04W 56/0045; H04W 24/10; H04W 28/06; H04W 72/1268; H04W 76/38

(57) ABSTRACT

Systems and methods for regulating uplink (UL) transmission timing differences (TTDs) at a user equipment (UE) are discussed herein. A UE may determine that a first uplink (UL) TTD between a first UL transmission timing for a first timing advance group (TAG) and a second UL transmission timing for a second TAG is above a threshold, may start a first TTD reconfiguration timer at the UE in response, and may send, to a network, a message indicating that the UE has started the first TTD reconfiguration timer. The network may then provide a configuration to the UE that lowers or renders inapplicable the UL TTD that is of concern. If no new network configuration is provided to the UE prior to expiration of the TTD reconfiguration timer, the UE may drop UL transmission use toward one of the TAGs. Considerations for thresholds for triggering such TTD reconfiguration timers are discussed.

### TECHNICAL FIELD

This application relates generally to wireless communication systems, including wireless communications systems supporting UEs that communicate with a network on multiple cells of different TAGs.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a diagram of a UE that performs a first UL transmission with a PCell and a second UL transmission with an SCell, wherein the PCell and the SCell are provided by separate (non-colocated) TRPs, according to embodiments discussed herein.

FIG. 1B illustrates a communication timeline illustrating the effects of the use of different TAs for different cells.

FIG. 2A illustrates a table for MTTD values that may be applicable with respect to various frequency range scenarios in the case of inter-band NR CA, as may be used in some wireless communication systems.

FIG. 2B illustrates a table for MTTD values that may be applicable with respect to various SCS scenarios in the case of inter-band asynchronous NE-DC, as may be used in some wireless communication systems.

FIG. 3 illustrates a diagram showing a UE using each of a PCell of a first TRP and a SCell of a second TRP, where the UE moves from a first position to a second position over time.

FIG. 4 illustrates a table detailing UE behavior with respect to the use of a TTD reconfiguration timer, according to embodiments herein.

FIG. 5 illustrates a method of a UE, according to embodiments herein.

FIG. 6 illustrates a method of a RAN, according to embodiments herein.

FIG. 7 illustrates a method of a RAN, according to embodiments herein.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

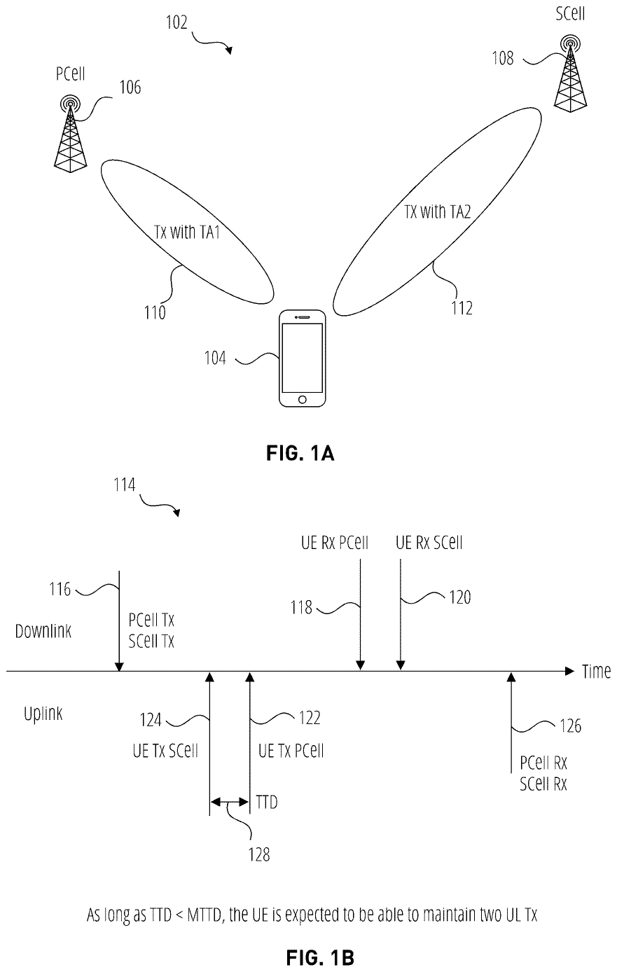

In some wireless communication systems, it may be expected that a UE can communicate with a network on multiple serving cells provided by non-colocated transmission reception points (TRPs) in a simultaneous manner. FIG. 1A illustrates a diagram 102 of a UE 104 that performs a first UL transmission 110 with a primary cell (PCell) 106 and a second UL transmission 112 with a secondary cell (SCell) 108, wherein the PCell 106 and the SCell 108 are provided by separate (non-colocated) TRPs, according to embodiments discussed herein.

The network may expect that various UL transmissions from the one or more UEs arrive at the PCell 106 and the SCell 108 simultaneously. To meet such timing requirements, the UE 104 UE may be capable of applying one or more timing advances (TAs) to one/both of the first UL transmission 110 and the second UL transmission 112. The a TA for a respective UL transmission adjusts the send time of the UL transmission from the perspective of the UE 104 such that a propagation time for the UL transmission is accounted for and the UL transmission is ultimately seen on the corresponding cell at the appropriate time from the perspective of the network.

Due to differences in the distances (and thus the propagation times) as between the UE 104 and the PCell 106 and the UE 104 and the SCell 108, the UE 104 may apply a first TA to a first UL transmission 110 with the PCell 106 and a second, different/independent TA to the second UL transmission 112 with the SCell 108.

FIG. 1B illustrates a communication timeline 114 illustrating the effects of the use of different TAs for different cells. The communication timeline 114 may correspond to the situation as between the UE 104, the PCell 106, and the SCell 108 of the diagram 102 as illustrated in FIG. 1A.

The network may perform downlink (DL) transmissions from each of the PCell 106 and the SCell 108 simultaneously, with a same DL transmit (Tx) timing 116. However, from the perspective of the UE, the DL transmissions are received at different times (the first DL receive (Rx) timing 118 and the second DL Rx timing 120), due to the distance (and thus propagation time) between the UE 104 and the PCell 106 being different than the distance/propagation time between the UE 104 and the SCell 108.

Corresponding aspects are applicable in the uplink (UL) direction. Accordingly, as illustrated, in order for a first transmission sent by the UE 104 on the PCell 106 and a second transmission sent by the UE 104 on the SCell 108 to arrive simultaneously at the network at a UL Rx timing 126 (which may be an assumed constraint for network UL reception within the wireless communication system), the UE may need to send the first transmission on the PCell 106 with a first transmission timing 122 and further send the second transmission on the SCell 108 with a second transmission timing 124 that is different than the first transmission timing 122.

Corresponding to such circumstances, each of the first transmission timing 122 and the second transmission timing 124 may be determined according to an (independent) TA for a timing advance group (TAG) in which the corresponding cell belongs. For example, the first transmission timing 122 may be determined according to a TA for a first TAG that includes the PCell 106, while the second transmission timing 124 may be determined according to an (independent) TA for a second TAG that includes the second transmission timing 124.

Thus, in general, it may be understood that the wireless communication system coordinates the configuration of TAs for the various TAGs of the various cells used by the UE such that all UL transmissions by the UE for those TAGs and on those cells arrive at the network simultaneously.

FIG. 1B further identifies a transmission timing difference (TTD) 128 that exists between the first transmission timing 122 and the second transmission timing 124 due to the arrangement just described. With respect to such TTDs, it may be that a UE of a wireless communication system is expected to be able to handle TTDs of values up to a defined maximum transmission timing difference (MTTD) defined within the wireless communication system (and that is applied, for example, as between two serving cells). Various examples where such an MTTD expectation may be defined/assumed within a wireless communication system are now provided. Note that in some uses herein as related to UL contexts, an MTTD may also be referred to as a “maximum uplink transmission timing difference.”

In a first example, a UE may be expected to be capable of handling a TTD of up to an MTTD as between a subframe timing boundary of an Evolved Universal Terrestrial Radio Access (E-UTRA) PCell and a closest slot timing boundary of a primary cell of a secondary cell group (PSCell) that are to be aggregated in the context of for E-UTRA-NR dual connectivity (EN-DC) operation.

In a second example, a UE may be expected to be capable of handling a TTD of up to an MTTD as between closest slot timing boundaries of different carriers in FR1 and/or Frequency Range 2-1 (FR2-1) that are to be aggregated in the context of NR carrier aggregation.

In a third example, a UE may be expected to be capable of handling a TTD of up to an MTTD as among the closest subframe timing boundaries of different carriers to be aggregated in FR1 and Frequency Range 2-2 (FR2-2) in the context of NR inter-band carrier aggregation.

In a fourth example, a UE may be expected to be capable of handling a TTD of up to an MTTD as between a slot timing boundary of a PCell and a subframe timing boundary of an E-UTRA PSCell that are to be aggregated in the context of NR-E-UTRA dual connectivity (NE-DC) operation.

In a fifth example, a UE may be expected to be capable of handling a TTD of up to an MTTD as between a slot timing boundary of a PCell in FR1 or FR2-1 and a closest slot timing boundary of a PSCell in FR1 or FR2-1 that are to be aggregated in the contexts of NR dual connectivity (DC) operation.

In a sixth example, a UE may be expected to be capable of handling a TTD of up to an MTTD as between a subframe timing boundary of a PCell in FRI and a closest subframe timing boundary of a PSCell in FR2-2 that are to be aggregated in the context of NR DC operation.

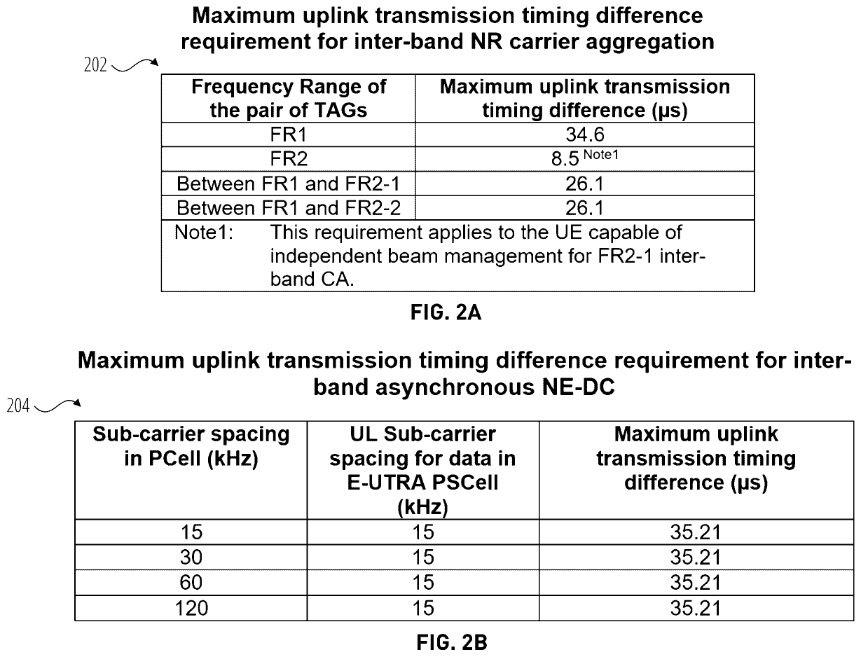

FIG. 2A illustrates a table 202 for MTTD values that may be applicable with respect to various frequency range scenarios in the case of inter-band NR carrier aggregation (CA), as may be used in some wireless communication systems.

FIG. 2B illustrates a table 204 for MTTD values that may be applicable with respect to various subcarrier spacing (SCS) scenarios in the case of inter-band asynchronous NE-DC, as may be used in some wireless communication systems.

It is noted that after a UE movement or rotation, an applicable TTD (and a received timing difference (RTD)) as between two serving cells may change, as the movement/rotation of the UE may change the applicable distance (and thus propagation delay) as between the Rx hardware of the UE and one or both of the serving cells.

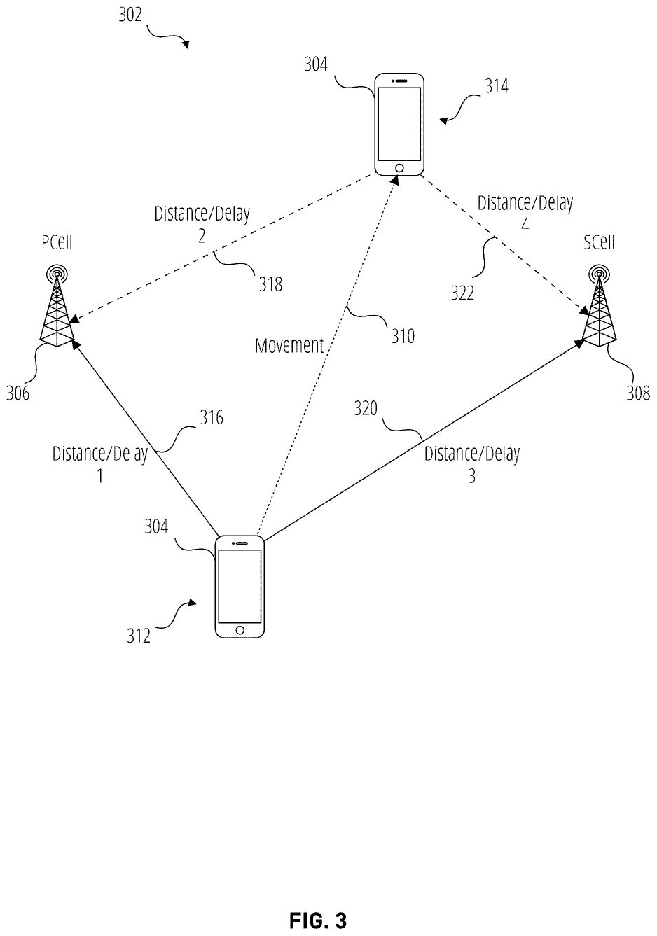

FIG. 3 illustrates a diagram 302 showing a UE 304 using each of a PCell 306 of a first TRP and a SCell 308 of a second TRP, where the UE moves 310 from a first position 312 to a second position 314 over time. As illustrated, the movement 310 of the UE 304 causes an effective distance between the UE 304 and the PCell 306 to change from the first distance 316 to the second distance 318 (which causes corresponding changes to the effective propagation time for signaling between the UE 304 and the PCell 306). Further, the movement 310 of the UE 304 also causes an effective distance between the UE 304 and the SCell 308 to change from the third distance 320 to the third distance 322 (which causes corresponding changes to the effective propagation time for signaling between the UE 304 and the SCell 308).

As discussed herein, in order to provide for expected uplink demodulation performance at the network, uplink signals from all UEs using the network may be expected to arrive at applicable TRPs of the network at the same time. Thus, it may be that to handle cases of UE movement and/or rotation, a wireless communication system may implement a UL timing adjustment mechanism that compensates for changed signal propagation times that apply after such movements/rotations. One or more of various possible such UL timing adjustment mechanisms may be used in various wireless communication systems.

A first example of a UL timing adjustment mechanism that may be used is a timing advance command (TAC) mechanism. Under a TAC mechanism, when the network realizes that an UL transmission timing at the UE has deviated from an expected timing, the network may send a TAC to the UE that instructs the UE adjust the UL transmission timing (e.g., instructs the UE to adjust one or more TAs used at the UE for those UL transmissions).

A second example of a UL timing adjustment mechanism that may be used is an autonomous UE UL timing adjustment mechanism. Under an autonomous UE UL timing adjustment mechanism, when an UL transmission it is not the first transmission in a discontinuous reception (DRX) cycle or there is no DRX cycle, and when the UL transmission is one of a physical uplink control channel (PUCCH) transmission, a physical uplink shared channel (PUSCH) transmission, or a sounding reference signal (SRS) transmission, the UE may be capable of changing a UL transmission timing used (e.g., changing an applied TA value) according to information inferred from an Rx timing for a downlink frame of a reference cell as experienced at the UE. Note that in some cases, it may be that an autonomous UE UL timing adjustment mechanism is not used in circumstances where a TAC is provided by the network (the TAC may take priority for controlling any adjustment in such cases).

Accordingly, circumstances may occur where an UL TTD between different UL transmission timings for two serving cells used by the UE is/becomes larger than an applicable MTTD (e.g., through the iterative application of one or more UL timing adjustment mechanisms). Further, it may be that the while the UL TTD as between the different UL transmission timings may be understood/known/calculable at the UE, this information is not known at the network (meaning that the network is unaware when an applicable MTTD condition is being exceeded at the UE). UE and/or network behavior under circumstances where an applicable MTTD condition is exceeded may not be defined for various wireless communication systems, meaning that there is potential for the wireless communication system to fail to operate as expected.

These problematic circumstances may be regulated through the use of a TTD reconfiguration timer at the UE. The TTD reconfiguration timer may be started in response to a UE determination that a TTD as between two serving cells has exceeded some threshold (where the threshold is, for example, an applicable MTTD as between the two serving cells, or a value derived at the UE based on such an applicable MTTD). The UE may stop/drop any implementation of any UL timing adjustments once the TTD exceeds this threshold value (e.g., while the TTD reconfiguration timer is running). The UE may further inform the network that the TTD reconfiguration timer is running. After notifying the network that the TTD reconfiguration timer is running, the UE may expect the network to provide some new configuration for the UE to use such that the TTD of concern is either reduced or rendered inapplicable. In a case that such a new configuration is not provided, upon expiration of the TTD timer, the UE may stops UL transmission use towards one of the serving cells.

With respect to some embodiments herein, it may be assumed that the existence of independent UL transmission timings at the UE for different serving cells is ultimately due to the fact that the different serving cells belong to different TAGs for which different TAs are applied. Accordingly, it should be understood that various UL transmission timings discussed herein may relate to corresponding TAGs. Thus, in embodiments herein, these various UL transmission timings may be referred to/differentiated according to their correspondences with those TAGs.

Further, it should also be understood that under such circumstances, applicable TTDs as between two serving cells of the UE (and any corresponding TTD reconfiguration timers used in response to UE determinations regarding those TTDs) can correspondingly be referenced/identified in terms of the two UL transmission timings of two different TAGs used by those two serving cells.

Accordingly, embodiments herein for handling cases where any reconfiguration or other action is implemented in order to resolve concerns that a TTD at a UE may exceed an applicable MTTD may be performed/described/understood on a TAG-wise basis. For example, where there is a concern that a TTD at a UE may exceed an applicable MTTD, a responsive reconfiguration from the network may cause the UE to stop UL transmission use on one of the TAGs for one of the serving cells that corresponds to the TTD.

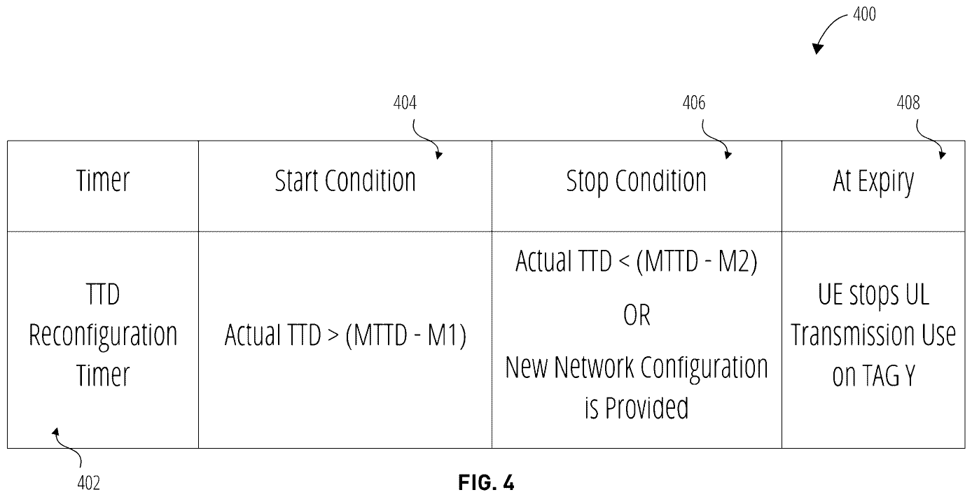

FIG. 4 illustrates a table 400 detailing UE behavior with respect to the use of a TTD reconfiguration timer 402, according to embodiments herein. Note that in some cases, the UE may use a single TTD reconfiguration timer 402 with respect to all TAGs used by the UE (e.g., the TTD reconfiguration timer 402 may be started/remain running when any TTD between any two TAGs of any two serving cells of the UE is of concern). In other cases, the UE may be configured to use independent TTD reconfiguration timers 402 as between each individual pair of TAGs, such that individual TTDs between individual ones these pairs of TAGs may be monitored individually. For example, in the case where the UE uses three serving cells on three different TAGs (TAG 1, TAG 2, and TAG 3), the UE may be configured to use (up to) three independent TTD reconfiguration timers concurrently (e.g., a first TTD reconfiguration timer for the pair TAG 1 and TAG 2, a second TTD reconfiguration timer for the pair TAG 2 and TAG 3, and a third TTD reconfiguration timer for the pair TAG 1 and TAG 3).

A start condition 404 for a TTD reconfiguration timer 402 may be that the UE determines that an actual/current TTD applicable between two serving cells of two different TAGs for that timer is greater than a threshold. In the start condition 404, the applicable threshold is equal to an applicable MTTD minus a margin value M1. As is described herein, the UE may inform the network when it starts the TTD reconfiguration timer 402. Accordingly, the use of the margin value M1 to lower this threshold value relative to the applicable MTTD value as illustrated configures the UE to start TTD reconfiguration timer 402 prior to a point where the applicable TTD actually exceeds the applicable MTTD (e.g., while the TTD is approaching, but has not yet exceeded, the MTTD). This may provide the network with some time to react to the starting of the TTD reconfiguration timer 402 prior to the applicable TTD actually exceeding the applicable MTTD value.

A first (independent) stop condition 406 for a TTD reconfiguration timer 402 may be that the UE determines that an actual/current TTD applicable between two serving cells of the two different TAGs for a timer is less than a threshold (or, in the case of a single shared TTD timer and more than two serving cells, the stop condition 406 may be that all TTDs as between all the serving cells are less than corresponding thresholds). In the stop condition 406, the applicable threshold is equal to an applicable MTTD minus a margin value M2. The use of the margin value M2 to lower this threshold value relative to the applicable MTTD may provide some level of confidence that a TTD is no longer near the point of exceeding the MTTD prior to stopping the TTD reconfiguration timer 402. As is described herein, the UE may inform the network when it stops the TTD reconfiguration timer 402.

In some cases, the margin values M1 and M2 may be set to different values such that an undesirable level of on/off “bouncing” of the TTD reconfiguration timer 402 is prevented.

One or both of the margin values M1 and M2 may be set in various ways. In a first case, one or both of the margin values M1 and M2 are pre-defined in a specification defining the behavior of the wireless communication system. For example, for a 3GPP NR wireless communication system, one or both of these margin values may be defined to be any of: 1 microsecond (μs); a quarter of an applicable cyclic prefix (CP); a value of 32*64*T_{c}, where T_{c} is a physical layer time unit for the system; etc.

In a second case, one or both of the margin values M1 and M2 are configured by the network. For example, radio resource control (RRC) signaling of an enumerated information element corresponding to various possible values (e.g., {1 μs, 2 μs, . . . }) may be provided from the network to the UE.

In a third case, one or both of the margin values M1 and M2 may be based on a capability of the UE and/or a declaration by the UE of the margin values M1 and M2 (e.g., that corresponds to such a UE capability).

A second (independent) stop condition 406 for a TTD reconfiguration timer 402 may be the reception of a new configuration from the network (e.g., that changes and/or renders inapplicable the effect of an applicable TTD that triggered the TTD reconfiguration timer 402, in the manner described herein).

An expiration behavior 408 of the UE corresponding to the case where the TTD reconfiguration timer 402 expires (e.g., without a stop condition 406 being fulfilled) may be that the UE stops UL transmission use on one of the two TAGs corresponding to the problematic TTD (TAG Y). Various mechanisms to identify the particular TAG Y for which UL transmission use is stopped may be used in such circumstances. In a first case, the particular TAG for which the UE stops UL transmission use may be indicated to the UE by the network. For example, assuming the case where the problematic TTD corresponds to TAG 1 and TAG 2 and where a PCell is in TAG 1 while an SCell is in TAG 2, the network may indicate to the UE that UL transmission use on TAG 2 should be stopped (e.g., the UE's use of the PCell is prioritized over the UE's use of the SCell).

In another case, the TAG Y for which UL transmission use is stopped may be determined to be any one of the TAGs (e.g., as determined by the UE).

As is described herein, the UE may inform the network when it has started and/or stopped a TTD reconfiguration timer. This information may be signaled from the UE to the network in any one or more of a random access channel (RACH) signaling, medium access control (MAC) layer signaling, and/or in uplink control information (UCI).

As is described herein, a UE may refuse to implement any UL transmission timing adjustment mechanism concerning either of two TAGs for which there is a running TTD timer.

Embodiments of new network configurations that may be provided in response to an indication from the UE to the network that a TTD reconfiguration timer is running are now provided. As described herein, after receiving an indication from a UE that a TTD reconfiguration timer has started, the network may provide the UE with a new configuration such that the applicable TTD of concern is reduced or rendered inapplicable.

In one case for a new network configuration, the network may stop scheduling UL transmissions for one of the TAGs.

Note that the following examples for new network configurations are given in a context where the problematic TTD is between a first TAG used by a master cell group (MCG) used by the UE and a second TAG used by a secondary cell group (SCG) used by the UE.

In a first example of a new network configuration under such circumstances, the network may stop scheduling UL transmissions on the SCG.

In another example of a new network configuration under such circumstances, the network may provide reconfiguration information to the UE that causes the UE to stop UL transmission use in the SCG (e.g., the UE falls back to single UL operation on the MCG).

In another example of a new network configuration under such circumstances, the network may deactivate the SCG with respect to the UE. In some such cases, the network may then proceed to attempt to activate another SCG with respect to the UE.

In cases where an SCG has been deactivated but not replaced, and where the network receives an indication from the UE that the TTD reconfiguration timer has stopped (e.g., due to the corresponding TTD at the UE falling back below a threshold), the network may attempt recover the SCG with respect to use of the SCG by the UE.

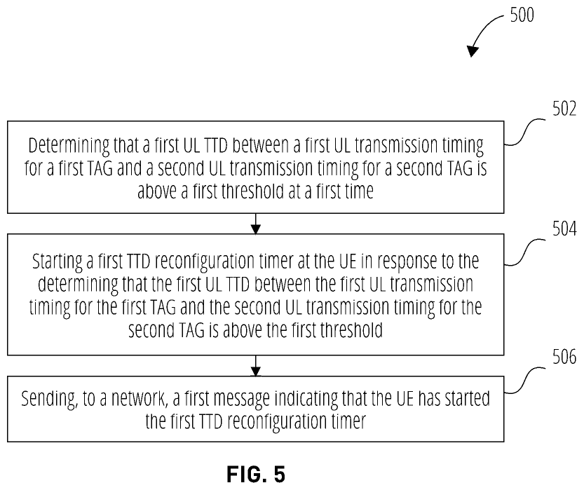

FIG. 5 illustrates a method 500 of a UE, according to embodiments herein. The method 500 includes determining 502 that a first UL TTD between a first UL transmission timing for a first TAG and a second UL transmission timing for a second TAG is above a first threshold at a first time. The method 500 further includes starting 504 a first TTD reconfiguration timer at the UE in response to the determining that the first UL TTD between the first UL transmission timing for the first TAG and the second UL transmission timing for the second TAG is above the first threshold. The method 500 further includes sending 506, to a network, a first message indicating that the UE has started the first TTD reconfiguration timer.

In some embodiments, the method 500 further includes determining that the first TTD reconfiguration timer has expired and dropping UL transmission use by the UE for the second TAG. In some such embodiments, the method 500 further includes receiving, from the network, a second message identifying the second TAG for the dropping of the UL transmission use when the first TTD reconfiguration timer expires.

In some embodiments, the method 500 further includes determining, while the first TTD reconfiguration timer is running, that the first UL TTD between the first UL transmission timing for the first TAG and the second UL transmission timing for the second TAG is below a second threshold at a second time; stopping the first TTD reconfiguration timer in response to the determining that the UL TTD between the first UL transmission timing for the first TAG and the second UL transmission timing for the second TAG is below the second threshold; and sending, to the network, a second message indicating that the UE has stopped the first TTD reconfiguration timer. In some such embodiments, the second threshold is equal to an MTTD for the UE minus a margin value. In some of these cases, the margin value is one of: pre-configured to the UE; configured to the UE by the network; and determined at the UE based on a UE capability.

In some embodiments of the method 500, the first threshold is equal to an MTTD for the UE minus a margin value. In some of these cases, the margin value is one of: pre-configured to the UE; configured to the UE by the network; and determined at the UE based on a UE capability.

In some embodiments, the method 500 further includes determining that a second UL TTD between the first UL transmission timing for the first TAG and a third UL transmission timing for a third TAG is above a second threshold at a second time; starting a second TTD reconfiguration timer at the UE in response to the determining that the second UL TTD between the first UL transmission timing for the first TAG and the third UL transmission timing for the third TAG is above the second threshold; and sending, to the network, a second message indicating that the UE has started the second TTD reconfiguration timer.

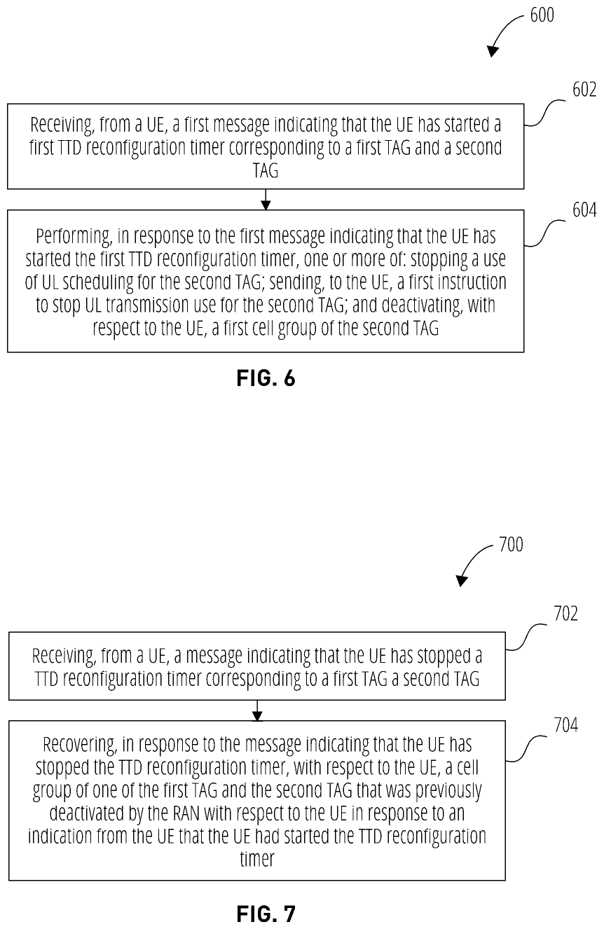

FIG. 6 illustrates a method 600 of a RAN, according to embodiments herein. The method 600 includes receiving 602, from a UE, a first message indicating that the UE has started a first TTD reconfiguration timer corresponding to a first TAG a second TAG. The method 600 further includes performing 604, in response to the first message indicating that the UE has started the first TTD reconfiguration timer, one or more of: stopping a use of UL scheduling for the second TAG; sending, to the UE, a first instruction to stop UL transmission use for the second TAG; and deactivating, with respect to the UE, a first cell group of the second TAG.

In some embodiments, the method 600 further includes identifying that a primary cell (PCell) used by the UE in the first TAG and sending, to the UE, a second message identifying the second TAG for a dropping of UL transmission use when the first TTD reconfiguration timer expires.

In some embodiments, the method 600 further includes receiving, from the UE, a second message indicating that the UE has started a second TTD reconfiguration timer corresponding to the first TAG a third TAG and performing, in response to the second message indicating that the UE has started the second TTD reconfiguration timer, one or more of: stopping a use of UL scheduling for the third TAG; sending, to the UE, a second instruction to stop UL transmission use for the third TAG; and deactivating, with respect to the UE, a second cell group of the third TAG.

FIG. 7 illustrates a method 700 of a RAN, according to embodiments herein. The method 700 includes receiving 702, from a UE, a message indicating that the UE has stopped a TTD reconfiguration timer corresponding to a first TAG a second TAG. The method 700 further includes recovering 704, in response to the message indicating that the UE has stopped the TTD reconfiguration timer, with respect to the UE, a cell group of one of the first TAG and the second TAG that was previously deactivated by the RAN with respect to the UE in response to an indication from the UE that the UE had started the TTD reconfiguration timer.

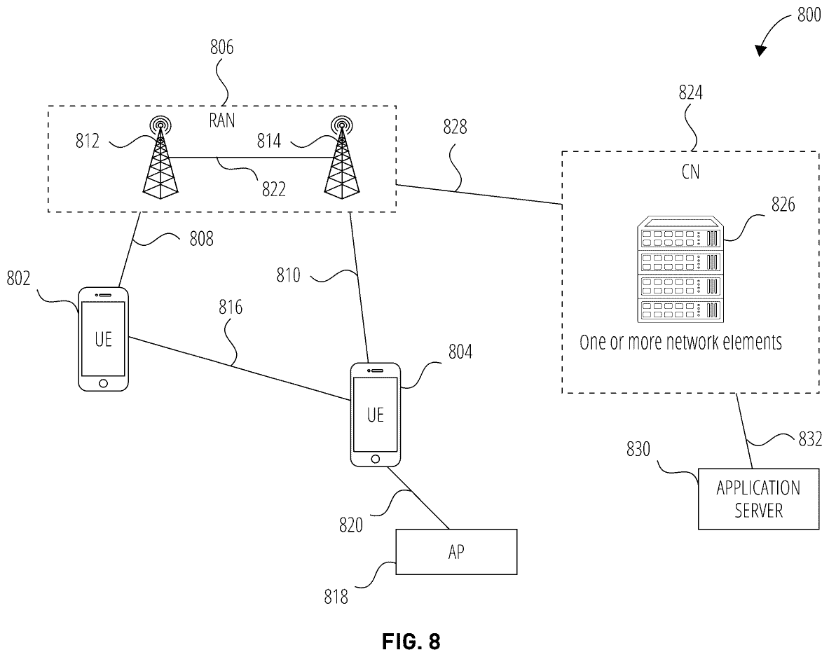

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an SI interface 828. In embodiments, the SI interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

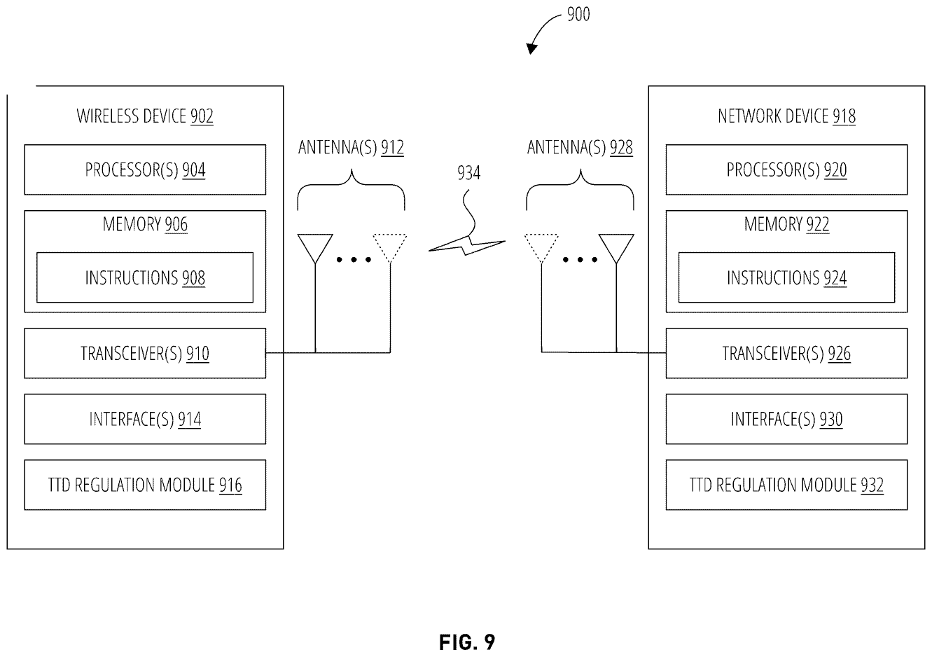

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter circuitry and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a TTD regulation module 916. The TTD regulation module 916 may be implemented via hardware, software, or combinations thereof. For example, the TTD regulation module 916 may be implemented as a processor, circuit, and/or instructions 908 stored in the memory 906 and executed by the processor(s) 904. In some examples, the TTD regulation module 916 may be integrated within the processor(s) 904 and/or the transceiver(s) 910. For example, the TTD regulation module 916 may be implemented by a combination of software components (e.g., executed by a DSP or a general processor) and hardware components (e.g., logic gates and circuitry) within the processor(s) 904 or the transceiver(s) 910.

The TTD regulation module 916 may be used for various aspects of the present disclosure, for example, aspects of FIG. 1A through FIG. 7. The TTD regulation module 916 may be configured to, for example: determine that an UL TTD between a first UL transmission timing for a first TAG and a second UL transmission timing for a second TAG is above a threshold at a first time, start a TTD reconfiguration timer at the UE in response to the determining that the first UL TTD between the first UL transmission timing for the first TAG and the second UL transmission timing for the second TAG is above the first threshold; send, to a network, a first message indicating that the UE has started the first TTD reconfiguration timer; determine that the first TTD reconfiguration timer has expired and drop a UL transmission use by the UE for the second TAG; determine, while a TTD reconfiguration timer is running, that a UL TTD between a first UL transmission timing for a first TAG and a second UL transmission timing for a second TAG is below a second threshold at a second time; stop a TTD reconfiguration timer in response to determining that a UL TTD between a first UL transmission timing for a first TAG and a second UL transmission timing for a second TAG is below the second threshold; and/or send, to the network, a second message indicating that the UE has stopped the first TTD reconfiguration timer (and to perform one or more of the behaviors with respect to multiple TTD reconfiguration timers for separate TAG pairs), in the manner that is described herein.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter circuitry and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a TTD regulation module 932. The TTD regulation module 932 may be implemented via hardware, software, or combinations thereof. For example, the TTD regulation module 932 may be implemented as a processor, circuit, and/or instructions 924 stored in the memory 922 and executed by the processor(s) 920. In some examples, the TTD regulation module 932 may be integrated within the processor(s) 920 and/or the transceiver(s) 926. For example, the TTD regulation module 932 may be implemented by a combination of software components (e.g., executed by a DSP or a general processor) and hardware components (e.g., logic gates and circuitry) within the processor(s) 920 or the transceiver(s) 926.

The TTD regulation module 932 may be used for various aspects of the present disclosure, for example, aspects of FIG. 1A to FIG. 7. The TTD regulation module 932 may be configured to, for example: receive, from a UE, a message indicating that the UE has started a first TTD reconfiguration timer corresponding to a TAG and a second TAG; perform,, in response to the first message indicating that the UE has started the first TTD reconfiguration timer, one or more of: stopping a use of UL scheduling for the second TAG; sending, to the UE, a first instruction to stop UL transmission use for the second TAG; and deactivating, with respect to the UE, a first cell group of the second TAG; receive, from a UE, a message indicating that the UE has stopped a TTD reconfiguration timer corresponding to a first TAG a second TAG; and/or recover, in response to the message indicating that the UE has stopped the TTD reconfiguration timer, with respect to the UE, a cell group of one of the first TAG and the second TAG that was previously deactivated by the RAN with respect to the UE in response to an indication from the UE that the UE had started the TTD reconfiguration timer, in the manner described herein.

Embodiments contemplated herein include an apparatus comprising means to perform one or more elements of the method 500. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 500. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 902 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

Embodiments contemplated herein include an apparatus comprising means to perform one or more elements of any of the method 600 and the method 700. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 600 and the method 700. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of any of the method 600 and the method 700. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 600 and the method 700. This apparatus may be, for example, an apparatus of a base station (such as a network device 918 that is a base station, as described herein).

Embodiments contemplated herein include a signal as described in or related to one or more elements of any of the method 600 and the method 700.

Embodiments contemplated herein include a computer program or computer program product comprising instructions, wherein execution of the program by a processing element is to cause the processing element to carry out one or more elements of any of the method 600 and the method 700. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
determining that a first uplink (UL) transmission timing difference (TTD) between a first UL transmission timing for a first timing advance group (TAG) and a second UL transmission timing for a second TAG is above a first threshold at a first time;
starting a first TTD reconfiguration timer at the UE in response to the determining that the first UL TTD between the first UL transmission timing for the first TAG and the second UL transmission timing for the second TAG is above the first threshold; and
sending, to a network, a first message indicating that the UE has started the first TTD reconfiguration timer.

2. The method of claim 1, further comprising:
determining that the first TTD reconfiguration timer has expired; and
dropping UL transmission use by the UE for the second TAG.

3. The method of claim 2, further comprising receiving, from the network, a second message identifying the second TAG for the dropping of the UL transmission use when the first TTD reconfiguration timer expires.

4. The method of claim 1, further comprising:
determining, while the first TTD reconfiguration timer is running, that the first UL TTD between the first UL transmission timing for the first TAG and the second UL transmission timing for the second TAG is below a second threshold at a second time;
stopping the first TTD reconfiguration timer in response to the determining that the UL TTD between the first UL transmission timing for the first TAG and the second UL transmission timing for the second TAG is below the second threshold; and
sending, to the network, a second message indicating that the UE has stopped the first TTD reconfiguration timer.

5. The method of claim 4, wherein the second threshold is equal to a maximum transmission timing difference (MTTD) for the UE minus a margin value.

6. The method of claim 5, wherein the margin value is one of:
pre-configured to the UE;
configured to the UE by the network; and
determined at the UE based on a UE capability.

7. The method of claim 1, wherein the first threshold is equal to a maximum transmission timing difference (MTTD) for the UE minus a margin value.

8. The method of claim 7, wherein the margin value is one of:
pre-configured to the UE;
configured to the UE by the network; and
determined at the UE based on a UE capability.

9. The method of claim 1, further comprising:
determining that a second UL TTD between the first UL transmission timing for the first TAG and a third UL transmission timing for a third TAG is above a second threshold at a second time;
starting a second TTD reconfiguration timer at the UE in response to the determining that the second UL TTD between the first UL transmission timing for the first TAG and the third UL transmission timing for the third TAG is above the second threshold; and
sending, to the network, a second message indicating that the UE has started the second TTD reconfiguration timer.

10. A method of a radio access network (RAN), comprising:
receiving, from a user equipment (UE), a first message indicating that the UE has started a first transmission timing difference (TTD) reconfiguration timer corresponding to a first timing advance group (TAG) and a second TAG; and
performing, in response to the first message indicating that the UE has started the first TTD reconfiguration timer, one or more of:
stopping a use of UL scheduling for the second TAG;
sending, to the UE, a first instruction to stop UL transmission use for the second TAG; and
deactivating, with respect to the UE, a first cell group of the second TAG.

11. The method of claim 10, further comprising:
identifying that a primary cell (PCell) used by the UE in the first TAG; and
sending, to the UE, a second message identifying the second TAG for a dropping of UL transmission use when the first TTD reconfiguration timer expires.

12. The method of claim 10, further comprising:
receiving, from the UE, a second message indicating that the UE has started a second TTD reconfiguration timer corresponding to the first TAG a third TAG; and
performing, in response to the second message indicating that the UE has started the second TTD reconfiguration timer, one or more of:
stopping a use of UL scheduling for the third TAG;
sending, to the UE, a second instruction to stop UL transmission use for the third TAG; and
deactivating, with respect to the UE, a second cell group of the third TAG.

13. A method of a radio access network (RAN), comprising:
receiving, from a user equipment (UE), a message indicating that the UE has stopped a TTD reconfiguration timer corresponding to a first timing advance group (TAG) a second TAG; and
recovering, in response to the message indicating that the UE has stopped the TTD reconfiguration timer, with respect to the UE, a cell group of one of the first TAG and the second TAG that was previously deactivated by the RAN with respect to the UE in response to an indication from the UE that the UE had started the TTD reconfiguration timer.

14-16. (canceled)
